(19) United States
(12) Patent Application Publication
(10) Pub. No.: US 2008/0289090 A1
(43) Pub. Date: Nov. 27, 2008

(54) PERFORMANCE WEAR FORMED OF HYDROPHOBIC MOISTURE MANAGEMENT FABRIC

(76) Inventor: Michael Brier, Miami, FL (US)

Correspondence Address: MALIN HALEY AND DIMAGGIO, PA, 1936 S ANDREWS AVENUE, FORT LAUDERDALE, FL, 33316, US

(21) Appl. No.: 12/127,325

(22) Filed: May 27, 2008

Related U.S. Application Data
(60) Provisional application No. 60/931,748, filed on May 25, 2007.

(51) Int. Cl. A62B 17/00; B32B 27/12

(52) U.S. Cl. 2/458; 442/79; 442/123; 442/136

(57) ABSTRACT

Performance wear made with hydrophobic fabric that maximizes evaporative cooling of the human body by maintaining perspiration and moisture at the surface of the skin whereby heat is more readily transferred from the skin by evaporative cooling thereby providing more effective core temperature regulation. The fabric may be natural or synthetic fiber or fiber blends having hydrophobic (e.g. water resistant) characteristics. The fabric is used to produce performance wear whereby the hydrophobic characteristics provide moisture management function by preventing moisture from migrating from the skin to the fabric. The hydrophobic performance fabrics are also preferably impregnated with antimicrobials, such as antibacterial, anti-odor, and antifungal substances, as well as flame retardant substances. The performance wear may comprise compression wear formed of a blend of polyester and spandex to provide increased movement, comfort, and fit.

### CROSS REFERENCE TO RELATED APPLICATIONS

This application claims the benefit of provisional U.S. Patent Application Ser. No. 60/931,748, filed on May 25, 2007.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to performance wear, and more particularly to hydrophobic moisture management performance wear adapted to assist in maintaining the wearer's core temperature within an optimal range during exercise and periods of strenuous activity. More particularly, the present invention relates to moisture management performance wear fabricated with performance enhancing fabric and fabric blends having various water-resistant, stain-resistant, anti-odor, antibacterial, antifungal, and flame retardant characteristics.

2. Description of Related Art

It has been found that hydration is vital for maximal performance and thermoregulation. Thermo regulation refers to the control of body temperature within a narrow range by addition or subtraction of body heat. As one may expect, body core temperature rises when heat gain exceeds heat loss, as commonly experienced during intense exercise. Since the metabolism of an elite athlete often rises 20 to 25 times above resting level, the human body can increase in temperature by 1 degree every six minutes in the absence of thermoregulatory intervention.

The human body primarily relies on the secretion of sweat from the more than 2.5 million sweat glands distributed on the surface of the human body. Sweat is derived from blood plasma filtration and has a composition of 99% water. One of the primary purposes of sweat is thermoregulation, i.e. the prevention of overheating. Sweat functions in the context of thermoregulation to cool the body by evaporation.

A number of attempts have been made in the art to provide performance garments that prevent overheating. Most such attempts rely on the use of a moisture management fabric designed to transport moisture away from the skin to the surface of the garment where it can be evaporated. For example, E.I. du Pont de Nemours and Company (“DuPont”) has developed several brands intended to provide beneficial moisture management benefits, including COOLMAX. The brands developed by Du Pont, however, depend on moisture management fabrics that draw moisture away from the wearer's skin to the fabric's surface whereafter the moisture evaporates. There are significant limitations and disadvantages with this technology. More particularly, by drawing moisture away from the skin for evaporation at the fabric surface this technology fails to fully realize the benefits of evaporative cooling of the skin. As a result, heat transfer resulting from the heat of evaporation occurs on the fabric rather than on the skin.

Accordingly, there exists a need for improvements in the art of performance wear. More particularly, there exists a need for improved performance wear adapted to maintain moisture at the skin level for evaporation thereby maximizing the effects of evaporative cooling on the skin. There further exists a need for improved performance wear formed of fabric impregnated with antifungal and antibacterial compounds to preserve hygienic freshness. There further exists a need for improved performance wear adapted with a substance that renders the fabric flame retardant.

### BRIEF SUMMARY OF THE INVENTION

The present invention overcomes the limitations present in the art by providing performance wear made with hydrophobic fabric that maximizes evaporative cooling of the human body by maintaining perspiration and moisture at the surface of the skin whereby heat is more readily transferred from the skin by evaporative cooling thereby providing more effective core temperature regulation. The fabrics may be natural or synthetic fiber or fiber blends having hydrophobic (e.g. water resistant) characteristics. The fabric is used to produce performance wear whereby the hydrophobic characteristics provide moisture management function by preventing moisture from migrating from the skin to the fabric. The hydrophobic performance fabrics may also be impregnated with antimicrobials, such as antibacterial, anti-odor, and antifungal substances, as well as flame retardant substances. The performance wear may comprise compression wear formed of a blend of polyester and spandex to provide increased movement, comfort, and fit.

Accordingly, it is an object of the present invention to provide improved performance wear.

Another object of the present invention is to provide moisture management performance wear that functions to assist in maintaining core temperature.

Still another object of the present invention is to provide performance wear that maintains moisture at the surface of the skin such to maximize heat transfer from the body.

These and other objects are met by the present invention which will become more apparent from the accompanying drawing and the following detailed description of the drawings and preferred embodiments.

### BRIEF DESCRIPTION OF THE SEVERAL VIEWS OF THE DRAWINGS

FIG. 1 depicts a hygrophobic performance fabric in accordance with the present invention;

FIG. 2 is a partial detail view thereof; and

FIG. 3 is a partial sectional view thereof taken along line 3-3 in FIG. 2.

### DETAILED DESCRIPTION OF THE INVENTION

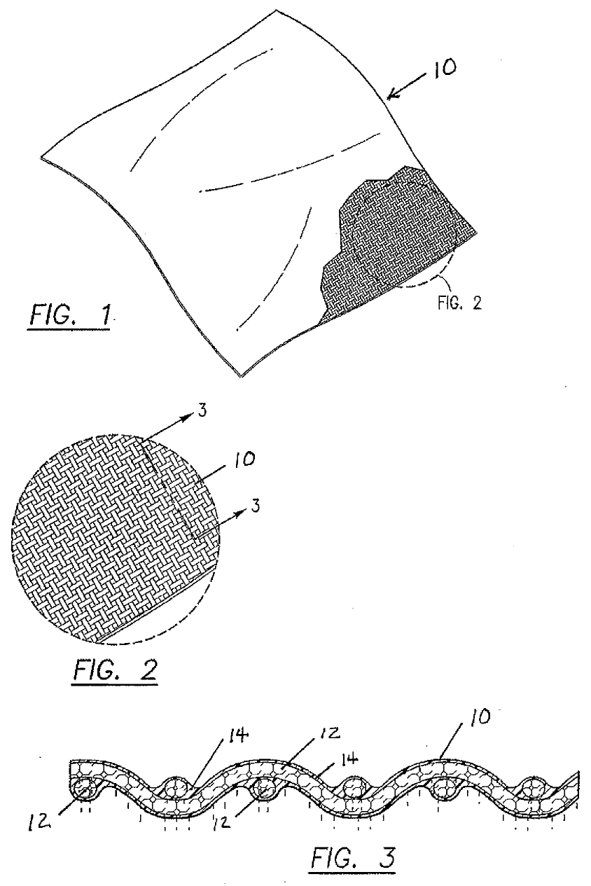

With reference now to the drawings FIGS. 1-3 depict a moisture management fabric, generally referenced as 10, for use in forming performance wear effective in core temperature regulation. Fabric 10 is used to form a performance garment, such as a shirt, shorts, headwear, socks, underwear, band, or other tops or bottoms. Fabric 10 preferably comprises woven cotton, however, the present invention contemplates a variety of fabric materials including woven and non-woven materials of natural and/or synthetic fibers, as well as various blends of such fabric materials. Fabric 10 is produced using a process that results in fabric 10 having hydrophobic characteristics. As a result of the hydrophobic characteristics of fabric 10, performance wear produced using fabric 10 prevents moisture from migrating from the skin to the fabric. Maintaining the moisture on the skin maximizes evaporative cooling of the human body at the surface of the skin, as opposed to the surface of the fabric, whereby heat is more readily transferred from the skin by evaporative cooling thereby providing more effective core temperature regulation. The hydrophobic performance fabrics may also be impregnated with antimicrobials, such as antibacterial, anti-odor, and antifungal substances, as well as flame retardant substances. The performance wear may comprise compression wear formed of a blend of polyester and spandex to provide increased movement, comfort, and fit.

Moisture management performance wear may be produced in accordance with a fabric treatment disclosed in U.S. Pat. No. 6,756,076, in the name of the present inventor, the disclosure of which is incorporated herein by reference, which provides a suitable process for producing a hydrophobic fabric. In accordance with that process fabric 10 is treated by: (1) bleaching the fabric with a suitable optical whitener; (2) affixing the fabric to a conveying machine; (3) applying approximately 7.0 lbs. of a water repellant solution, comprising approximately of 5.0 lbs. of Marpel FC and approximately 2.0 lbs. of Marpel SG, for each approximately 100 lbs. of fabric by conveying the fabric through a pad bath; (4) conveying the fabric through a tenter frame machine having a heating chamber set a approximately 340° F. (4) conveying the treated fabric through the heating chamber at a speed of approximately 17 yards per minute; (5) repeating step 4 a second time to effect curing of the chemicals thereby resulting in a water-resistant fabric. The names Marpel SG and Marpel FC are trademarks for chemicals produced by Marlin Chemical Company, 1211 Underdown Ave., Lenoir, N.C. 28645. Another suitable water repelling agent is identified as Apex Waterprofer 253.

The present invention further improves upon the inventors prior work by disclosing a method wherein resin is added to the chemical mix to control the amount of waterproofness to the fabric, e.g. cotton, to selectively substantially close up the intersticial space defined between the fibers as deemed necessary or desirable. The term “resin” refers to a hydrocarbon secretion of many plants, particularly coniferous trees. As used herein, the term “resin, further includes synthetic substances having properties similar to natural resin. In a preferred embodiment, products will need be completely waterproof, and in alternate embodiments the products may need to allow for more air to circulate. In accordance with this aspect of the present invention the amount of water resistance solution may be increased in order to improve water resistance by substantially filling the interstitial spaces between the fibers or conversely decreased to lessen water resistance by leaving the interstitial spaces between the fibers unfilled. Any suitable natural or synthetic resin may be used.

The bleaching process removes impurities and typically includes use of a suitable optical brightener for whitening the fabric. Suitable bleaching agents include, chlorine, peroxide, and reducing agents such as sulphites. The bleaching agent may be centrifugally extracted after a suitable or predetermined period of time. A tenter is a machine that dries and stretches cloth to its finished width, and straightens the weave by the action of two diverging endless chains. Each chain is equipped with a series of clips or pins that hold the edges of the cloth and convey it over gas flames or through a hot-air drying compartment.

Once treated the fabric's fiber surface is effectively altered to make it repel water. It has been found that water drops are repelled by the treated fabric and run over the surface rather than being absorbed, while the mechanical properties and the visual appearance remain unchanged. In addition, the fabric retains the ability to breathe, e.g. permeability to air. Cotton fabric treated in accordance with the process of the instant invention remains substantially hydrophobic for extended periods and numerous machine washings.

FIG. 1 depicts a portion of fabric, generally referenced as 10, produced in accordance with the present invention. FIG. 2 is a detail view of a portion of fabric 10 and illustrates the weaving of individual fibers, each referenced as 12. FIG. 3 is a side sectional view of fabric 10 as seen along section lines 3-3 in FIG. 2. As best seen in FIG. 3, each fiber 12 has a coating 14 comprising the chemical composition applied by the pad bath portion of the process and subsequently cured by the drying portion of the process. Coating 14 provides a water repelling barrier that prevents saturation of the fibers and hence the fabric. In accordance with a preferred embodiment, coating 14 typically does not fill the interstitial spaces formed in the fabric weave to as to allow air, but not water, to pass through the fabric. The ability to allow air, but not water, to pass through is considered a significant aspect of the present invention, namely providing moisture management performance wear that maintains the wearer's perspiration on the skin where evaporation directly from the skin (as opposed to wicking the moisture away) maximizes cooling.

A significant aspect of the present invention relates to the use of hydrophobic fabric produced in accordance with the present invention in the production of performance wear. Using hydrophobic fabric to produce performance wear runs counter to the conventional teachings in the art wherein the fabric is modified to wick moisture away from the body. The present inventor has found that by providing performance wear formed of hydrophobic fabric that prevents moisture from passing through the fabric while allowing air to permeate results in improved thermoregulation of the user's core temperature. Accordingly, a significant aspect of the present invention relates to providing performance wear that is effective in cooling the user by evaporation of moisture directly from the user's skin as opposed to transporting the moisture to the surface of the fabric as taught in the prior art.

As note above, the present invention further contemplates a process for producing hydrophobic fabric impregnated with antimicrobials, such as anti-bacterial, anti-odor, and anti-fungal substances. Hydrophobic fabric having antimicrobial characteristics may be used to produce a wide variety of performance wear articles including undergarments, shirts, shorts, tights, and the like while functioning to inhibit the growth of odor-causing bacteria, fungi, molds and mildew. As a result, the fabric possesses a characteristic that will mask odors, but also prevents the actual causes of odors. The fabric further promotes hygiene by reducing the number of germs that can be transmitted and further by reducing the potential for allergic responses.

Accordingly, the process may be adapted to produce fabric having both antibacterial and water repellant properties according to the following steps: (1) bleaching the cotton fabric with a suitable optical whitener; (2) affixing the fabric to a conveying machine; (3) applying approximately 3.0 lbs. of antibacterial substance and 2.0 lbs. of water repellant for each approximately 100.0 lbs. of cotton fabric by conveying the fabric through a pad bath; (4) conveying the fabric through a tenter frame machine having a heating device set for approximately 325° F. at a speed of approximately 40 yards per minute; (5) repeating step (4) a second time to effect curing of the chemicals thereby resulting in a water-resistant cotton fabric.

A suitable bacteriostat for textiles is available from Marlin Chemical Company or Lenoir, N.C., under the trademark Microfin Protectant 100. The active ingredient of Microfin Protectant 100 is trielosan (a trademark for 2,4,4-trichloro-2 hydroxydiphenyl ether), a phenolic derivative emulsified in water so that it can be applied to textiles to impart high resistance to the growth of bacteria durable to many washings. In alternate embodiments, the present invention contemplates use of antibacterial and antifungal compounds such as those available from Thompson Research Associates, a subsidiary of Kroy Chemicals, Ltd. (e.g. NMB2 Antibacterial), however, the use of any suitable equivalent compounds is considered within the scope of the present invention.

In still another alternate embodiment a flame retardant chemical may be used to provide a flame retardant fabric. In a preferred embodiment, a suitable flame retardant chemical, such as Tetrakis (hydroxymethyl) Phosphonium (chloride or sulfate) plus Nitrogen, commonly referred to as THPS, is used.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. In a performance garment, the improvement comprising a moisture management component for preventing moisture from moving away from the skin of a wearer so as to maximize evaporative cooling of the human body thereby providing more effective core temperature regulation, said moisture management component including:
fabric formed of woven fibers, said fibers defining intersticial spaces therebetween;
said fabric treated with a water repelling agent;
said water repelling agent substantially filling said intersticial spaces such that moisture is substantially prevented from being absorbed into said fabric while air is allowed to penetrate said fabric;
said water repelling agent thereby maximizing evaporative cooling of the human body by preventing moisture from moving away from the skin of a wearer so as to maximize evaporative cooling of the human body.

2. In a performance garment according to claim 1, said water repelling agent including a resin.

3. In a performance garment according to claim 1, said resin comprises a natural resin.

4. In a performance garment according to claim 1, said resin comprises a synthetic resin.

5. In a performance garment according to claim 1, said fabric comprising cotton.

6. In a performance garment according to claim 1, said fabric comprising synthetic material.

7. In a performance garment according to claim 1, wherein said fabric is further treated with an anti-microbial substance.

8. In a performance garment according to claim 1, wherein said fabric is further treated with an ant-fungal substance.

9. In a performance garment according to claim 1, wherein said fabric is further treated with an anti-bacterial substance.

10. In a performance garment according to claim 1, wherein said fabric is further treated with an anti-odor substance.

11. In a performance garment according to claim 1, wherein said fabric is further treated with a flame retardant substance.

12. In a performance garment, the improvement comprising a moisture management component for preventing moisture from moving away from the skin of a wearer so as to maximize evaporative cooling of the human body thereby providing more effective core temperature regulation, said moisture management component including:
fabric formed of woven fibers, said fibers defining intersticial spaces therebetween;
said fabric treated with a water repelling agent, said water repelling agent including resin;
said fabric treated with an anti-microbial substance;
said fabric treated with an anti-odor substance;
said water repelling agent substantially filling said intersticial spaces such that moisture is substantially prevented from being absorbed into said fabric while air is allowed to penetrate said fabric;
said water repelling agent thereby maximizing evaporative cooling of the human body by preventing moisture from moving away from the skin of a wearer so as to maximize evaporative cooling of the human body.

13. In a performance garment according to claim 12, said resin comprises a natural resin.

14. In a performance garment according to claim 12, said resin comprises a synthetic resin.

15. In a performance garment according to claim 12, said fabric comprising cotton.

16. In a performance garment according to claim 12, said fabric comprising synthetic material.
